(19) United States
(12) Patent Application Publication
(10) Pub. No.: US 2024/0357957 A1
(43) Pub. Date: Oct. 31, 2024

(54) PLANTING DEVICE FOR PLANTING ROOT CROPS

(71) Applicant: Grimme Landmaschinenfabrik GmbH & Co. KG, Damme (DE)

(72) Inventors: Ansgar Lange gen. Detert, Melle (DE); Werner Plöger, Bohmte (DE); Henrik Wulferding, Ehrenburg (DE)

(21) Appl. No.: 18/645,256

(22) Filed: Apr. 24, 2024

(30) Foreign Application Priority Data
Apr. 26, 2023 (DE) 202023102248.0

(51) Int. Cl. A01C 9/02

(52) U.S. Cl. CPC A01C 9/02

(57) ABSTRACT

Planting device for planting root crops comprising a cup hopper and at least one conveying device. The conveying device includes at least one carrier element, several conveying elements arranged on the carrier element, and a guide apparatus with at least one guide element which is formed to guide the propagating crops into an output region. Respective conveying elements describe, during operation, a path which runs through the cup hopper to pick up propagating crops. The guide apparatus is arranged such that a vertical proportion of the output direction is smaller than a horizontal proportion of the output direction.

### CROSS REFERENCE

This application claims priority to German Application No. 20 2023 102248.0, filed Apr. 26, 2023, the entirety which is hereby incorporated by reference.

### FIELD OF THE INVENTION

The present invention relates to a planting device for planting root crops, in particular a planting device preferably formed as a cup planting machine for potatoes, comprising a cup hopper for the provisioning of propagating crops of the root crops to be separated out, for example, potato tubers, and at least one conveying device which is formed to output the propagating crops and which comprises at least one carrier element which revolves in a direction of rotation during operation, several conveying elements arranged on the carrier element and a guide apparatus with at least one guide element, which is formed to guide the propagating crops in an output region in such a manner that the propagating crops are output in the output region in an output direction from the planting device, wherein respective conveying elements describe, during operation, a path which runs through the cup hopper in order to pick up a potato.

### BACKGROUND OF THE INVENTION

Such a planting device is described, for example, in US 2006/283363 A1. When discharging potatoes from the planting machine moved on the ground, it arises that the propagating crops formed as potato tubers or potatoes do not come to lie in the desired position as a result of high differences in speed between the conveying device and the ground. Moreover, interfering influences of any parts of the conveying device can exert undesirable impulses on the propagating crops, hence the output direction is more difficult to define. Overall, this leads to the distances between the potato nests or potato plants of a row varying to an undesirably great extent.

### BRIEF SUMMARY OF THE INVENTION

The object of the present invention is to enable more precise discharge of the propagating crops of the root crops to be harvested later from the planting device.

According to the invention, the guide apparatus is arranged in such a manner that a vertical proportion of the output direction is smaller than a horizontal proportion of the output direction, in particular wherein the output direction runs at least approximately and preferably precisely horizontally and thus runs parallel to the flat ground. The horizontal movement proportion of the output root crops is greater than the vertical movement proportion as a result of the movement brought about by the planting device and possibly gravity when exiting from the planting device so that the relative speed between propagating crop and the ground is lower than the horizontal relative speed between planting device and ground. The relative speed is also reduced in a controlled manner in comparison with the planting devices from the prior art as a result of the use of the guide apparatus between the propagating crop and the ground. The output direction corresponds in this case to the vector of the output speed. The output direction of the propagating crop should correspondingly also be regarded as a vector which, in a side view, viewed transverse to the main direction of travel in the direction parallel to the ground, has according to the invention a horizontal component or x-component which at the output or discharge moment of the propagating crop is (significantly) larger than a vertical component. As a result of the reduced relative speed, the propagating crop can be deposited in a more composed and targeted manner on the ground, the propagating crop, for example, a potato tuber, has a smaller horizontal movement impulse relative to the ground. In particular, during operation, an acceleration arises in the perpendicular direction to the ground only after discharge from the guide apparatus. The vertical speed of the propagating crop is thus likewise reduced, which likewise leads to an improved depositing of the propagating crop.

The output direction is opposite to an intended direction of movement of the planting device during operation, in particular completely or almost completely opposite. Almost completely opposite in this case encompasses angle deviations of up to 10° from the horizontal. The output direction is viewed here in a side view, perpendicular to the direction of movement. In a plan view from above, the output direction and the direction of movement are preferably completely opposite.

The output direction is regarded (in the side view) in particular as opposite to the direction of movement when an angle deviation of at most 45°, preferably at most 20° from the horizontal arises, the output direction therefore being correspondingly inclined. As horizontal as possible discharge is preferred.

The direction of movement of the planting device is the direction in which the planting device is either moved independently or pulled in the course of its intended use when planting propagating crops. The propagating crops are thus discharged to the rear from the planting device in particular in the direction of movement. From discharge from the planting machine, the propagating crop follows, as a result of the superimposed gravitational acceleration, a parabolic trajectory with a vertical speed proportion which increases with the drop height. The initially incorporated horizontal speed remains almost constant during the drop period since it is only insignificantly influenced by factors such as, for example, air resistance. The relative speed of the propagating crop to the ground at the time of discharge is lower than the relative speed of the planting device to the ground so that the propagating crop is deflected to a lesser extent when it hits the ground and thus the actual distances between individual propagating crops within a furrow remain closer to the desired distance. As a result of the gravitational acceleration, the vertical speed of the propagating crop at the time of hitting the ground can be greater than the horizontal speed component of the movement.

In the case of the present consideration, it is assumed that, in the case of use as intended, the planting device moves on horizontally running ground and in this regard forms a horizontal contact surface. The horizontal and vertical proportions of the output direction then relate to such a contact surface. A guide element can furthermore be constructed in one or multiple parts.

The output region is the region through which the propagating crop moves after being released by the conveying device or the guide apparatus. The guide element is arranged at least in portions preferably below the carrier element. The output region in which the propagating crop is released by the conveying device is also located below and partially in front of individual elements of the planting device. The carrier element and the guide element are mounted directly or indirectly on a device frame of the planting device.

During operation, the conveying element is arranged on the carrier element and revolves with it. After separating the propagating crops and any deflection of the propagating crops with the revolving conveying element, it is particularly advantageous if the guide element is formed for a deflection of the propagating crops by at least 30°, preferably by at least 45° and particularly preferably by at least 60°. An advantageous upper limit is a deflection of 100° and in particular of 90°.

As a result of the formation of the guide element(s), the propagating crop is deflected from an almost vertical movement, as arises in particular in the case of cup planting machines, into a movement with a substantial horizontal proportion, i.e. which exceeds at least 45°.

The guide element is preferably formed in a stationary manner relative to a device frame at least during operation. The conveying elements which revolve during operation can correspondingly guide the propagating crops along the guide element. Alternatively, the propagating crops can also be deflected by the guide element as a result of gravity-induced acceleration or acceleration brought about by the carrier element.

The guide element can advantageously be formed as a guiding surface element, in particular as a guiding plate or as a plastic element, with a guiding surface which faces in particular the carrier element and in particular which is provided to centre propagating crops separated out by the conveying elements. Such a low-cost construction is suitable, in particular in combination with a guiding of the propagating crops along the guiding plate brought about by the conveying elements, for depositing the propagating crops in a targeted manner on the ground.

For the purpose of centring, the guiding surface is, as viewed in the conveying direction, provided in particular with a concave profile which has a central hollow and higher outer edges or sides.

Alternatively to a guide element which is stationary during operation, this guide element can also be formed during operation to be revolving, in particular wherein the guide element moves at least in portions in the direction of the output direction and thus this influences the speed of the propagating crop in a targeted manner. As a result of this, a particularly controlled discharge of the propagating crops is possible.

The guide element in particular involves one or more revolving belts on which the propagating crops supplied above the belt come to lie as a result of gravity and are then conveyed thereby in the direction of the discharge region. The at least one revolving guide element can in this case also be arranged so close to the conveying elements that it touches these and bears against these. As a result of this, once again seen in a side view, conveying chambers are formed which particularly effectively bring about a deflection and controlled conveying of the propagating crops.

It will be obvious that the regions of the conveying device, in which propagating crops are conducted or conveyed by the guide elements in the vertical direction and in the direction with or in particular counter to the direction of travel, are or can be laterally delimited in prevent the propagating crops from falling to the side. These lateral delimitations, insofar as they should expediently or necessarily be present, are not mentioned in the profiles of the guide elements described in greater detail below.

The planting device or the guide apparatus of the planting device is advantageously provided with a multiplicity of guide elements, wherein at least one of the guide elements is formed as a guiding surface element, in particular as a guiding plate, and one of the guide elements is formed in a revolving manner during operation. In the case of such a guide apparatus, in particular a deflection via a guiding plate can be combined with a speed control via a revolving guide element, e.g. in the form of a conveyor belt. A plastic guiding element can also be used instead of a guiding plate.

According to a further advantageous formation of the invention, the carrier element formed in particular as a belt strip is mounted by at least two and in particular by at least three deflection elements which rotate during operation in such a manner that a carrier element portion which adjoins the output region runs during operation at least substantially in a straight line and in particular in the output direction. A horizontal depositing of the propagating crops in the direction of the discharge region and in particular also a controlled movement of the propagating crop in the output direction are facilitated with a lower portion, e.g. in a straight line in a side view, by means of the carrier element.

As an alternative to such a straight portion, a discharge according to the invention of the propagating crops can be facilitated in the case of a cup planting machine by a single lower deflection roller provided with a large diameter, in particular between 100 and 700 mm. In particular in the case of a cup planting machine according to the invention with an upper and a lower deflection roller for the carrier element, the diameter of the upper deflection roller is smaller than and in particular at most half the size of a lower deflection roller.

The guiding surface is provided in particular for centring by the conveying elements when, as viewed in the output direction, two rows of conveying elements are arranged on the carrier element, the separated out propagating crops of which should equally be deposited in only one row. Such a centring can be implemented, for example, by a concave formation, also described above, of the guiding surface element, in particular of a guiding plate (viewed in the discharge direction).

In the case of a mounting of the revolving guide element formed in particular as a conveyor belt via at least two deflection elements, these deflections can be formed, between which the guide element runs almost or completely horizontally so that a conveying of the propagating crops is performed in particular horizontally to the ground. In order to avoid undesirable vibrations of the conveyor belt, this can be assisted in the portion at the bottom side by a guiding surface element, e.g. a guide plate.

According to a further configuration of the invention according to the invention, the guide apparatus preferably comprises a counter-guidance element which revolves during operation in particular at least in portions parallel to the guide element and/or in the output direction, the direction of rotation of which can be the same or also different to the direction of rotation of the carrier element. Both the guide element and the counter-guidance element are located below the carrier element in particular towards the discharge region. The discharge of the propagating crop is performed with an influence thereon by the guide element and the counter-guidance element so that the propagating crops can be transferred particularly well and in a targeted, controlled manner to the discharge region.

In particular, the guide apparatus has several driver elements which revolve during operation, are arranged in particular on the guide element and/or on the counter-guidance element and extend locally at an angle to the direction of rotation, which in addition or also as an alternative to a conveying of the propagating crops through the conveying elements to the output region can carry along and move along the propagating crops. In particular, the distance between the driver elements in the direction of rotation of the guide element and counter-guidance element is so large that the propagating crops come to lie between these.

The guide apparatus, in particular the guide element and/or the counter-guidance element, advantageously has an upper end portion which is further spaced apart from a contact surface than a rotational axis of a lower deflection element which rotates during operation and deflects the carrier element. In this respect, the guide apparatus can also already act on propagating crops which are transported initially substantially vertically in particular in the case of cup planting machines and conduct these in the direction of the output region. For example, a guiding plate which brings about a deflection projects correspondingly high on the conveying element.

The guide apparatus, in particular the guide element and/or the counter-guidance element, preferably has a roller which rotates during operation with a concave shell surface, by means of which a centring of the propagating crops is achieved if these are taken in one or two rows from a common hopper region.

A centring and partially also gravity-induced positioning of the propagating crops on a guide element is in particular also supported in that if, according to a further embodiment of the invention, an element of the guide apparatus, in particular the guide element and/or the counter-guidance element, is formed in a revolving manner as a deflection axis which is at an angle, in particular at a right angle, to a horizontal. These are preferably formed in mirror-symmetry in the direction of the discharge of the propagating crop when using a guide element and a counter-guidance element in order to be able to bring about optimal guidance of the propagating crops between them.

In particular, the guide element and the counter-guidance element have outer surfaces which respectively face one another in regions and which are formed from a material which is at least partially flexible for a clamping of propagating crops arranged between the guide element and the counter-guidance element. Such surfaces formed, for example, from rubber or foam lead to a reliable and controlled carrying along of the propagating crops which in each case assume the rotational speed of the guide element and of the counter-guidance element and are thus conveyed in a particularly well controlled manner in the output region in the output direction.

The guide element preferably runs at least in portions, in particular in a lower end region, at least substantially parallel to the counter-guidance element or the carrier element, wherein this view applies in particular to the surfaces of the guide and conveying elements, regardless of any drivers or conveying elements.

In order to enable particularly good control of the output direction, the planting device furthermore comprises according to the invention a control device which is formed to actuate the guide apparatus, in particular the guide element and/or the counter-guidance element, as a function of a speed of movement. In this case, the control device can be formed in particular for such an actuation that a rotational speed of the guide element or the counter-guidance element is formed as a function of the speed of movement of the planting device and in particular proportional to this. Alternatively or additionally, the control device can also be formed in such a manner that an otherwise stationary guide element in the form of a guiding surface element, in particular of a guiding plate, is kept adjustable by means of an actuating means and in order to change the output direction. Such a control device includes conventional means such as sensors or interfaces to detect inputs, for example, the speed of the carrier element or a speed of movement, preferably IT means or at least electric means to identify the desired drive signals as well as control lines to transmit the signals to the associated drive elements of the carrier and guide elements.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a planting device according to the invention.

FIG. 2 shows a part of a planting device according to the invention.

FIG. 3 shows parts of the subject matter according to FIG. 2 in a side view.

FIG. 4 shows a front view of a part of the subject matter according to FIG. 3.

FIG. 5 shows a side view of a part of a further planting device according to the invention.

FIG. 6 shows an identical side view of the part of a further planting device according to the invention according to FIG. 5.

FIG. 7 shows speed profiles for propagating crops conveyed by the planting device according to FIG. 6.

FIG. 8 shows a plan view of a part of a further planting device according to the invention.

### DETAILED DESCRIPTION OF THE DRAWINGS

Individual technical features of the exemplary embodiments described below can also be combined in combination with exemplary embodiments described above as well as the features of an independent claim and any further claims to form subject matters according to the invention. Insofar as is expedient, elements which at least partially have an identical function are provided with identical reference numbers.

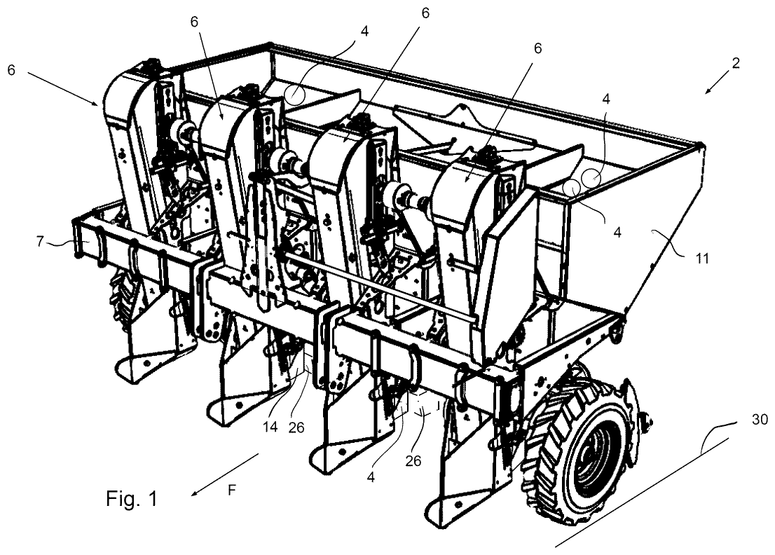

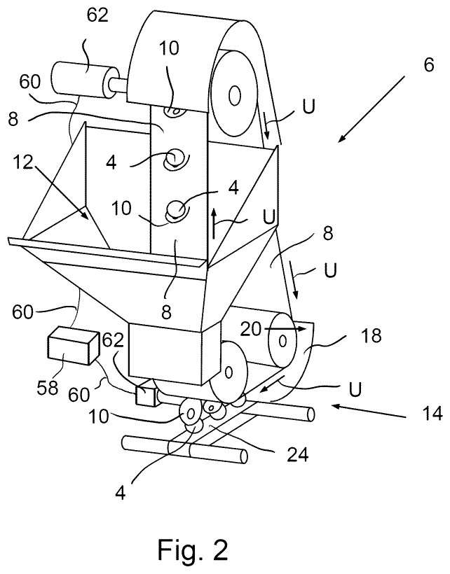

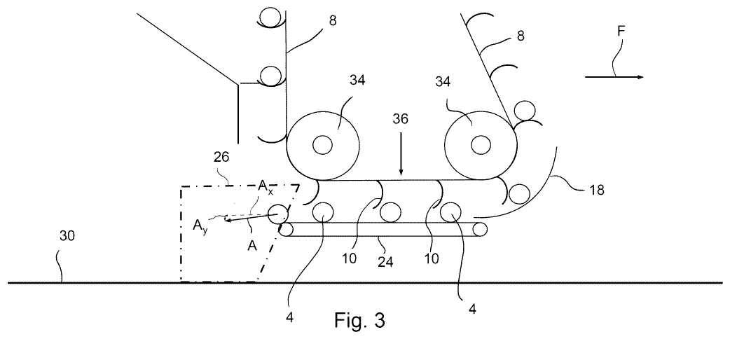

A planting device formed as a cup planting machine for root crops can, as represented in FIG. 1, be formed as a drawn cup planting machine 2 via which propagating crops 4 (represented partially by dashed lines) in the form of potatoes are sown in the ground. For this purpose, there are several conveying devices 6 arranged fixedly on a device frame 7, with in each case a carrier element 8 which during operation revolves in a direction of rotation U and is formed in the present case as a cup belt (FIG. 2). This has conveying elements 10 arranged consecutively in direction of rotation U in the form of scoops. During operation, the propagating crops 4 are firstly transferred from a bunker 11 into a cup hopper 12 from which they are removed by means of the conveying elements 10 in a separated out manner via the carrier element 8 of the conveying device 6. In order to guide and convey the propagating crops 4 in the direction of an output region 26, a guide apparatus 14 is present (FIG. 3) which has a multiplicity of guide elements which interact partially with one another. On one hand, a guide element formed as a guiding plate 18 is present which has a guiding surface 20 which faces the carrier element 8. A further guide element formed as guide plate 22 can in this case have guiding surfaces 23 provided in particular for centring which support a further guide element which revolves during operation in the form of a revolving belt strip 24.

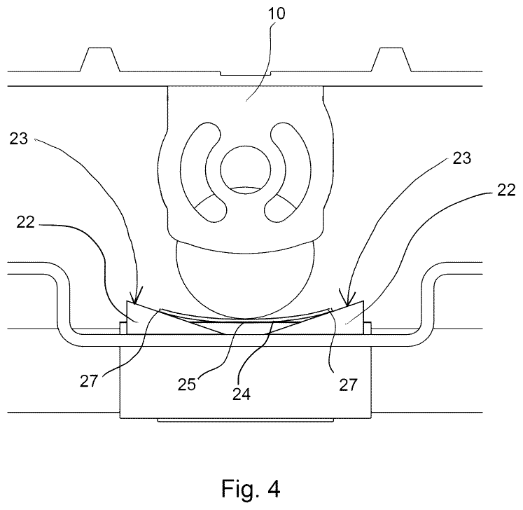

The belt strip 24 lies partially on the guiding surfaces 23 of the guide plate 22 and thus takes on, in the view of FIG. 4 and viewed in the conveying direction, a concave shape with a deeper centre 25 and in comparison thereto relatively higher sides 27 so that the propagating crops 4 initially transported on the guiding plate 18 or on the following belt strip 24 lie centred on the belt strip 24 as a result of gravity.

The output region 26 is the region in which and through which the propagating crops 4 are moved after their discharge from the planting device. It thus adjoins the guide apparatus 14 and extends to the ground, wherein the exact form of the discharge region 26 can vary depending on the guide apparatus 14.

Alternatively, the guide element 22 can also involve one or more rollers which rotate during operation and have a concave surface.

The conveying elements 10 describe during operation a path which revolves in direction U and which runs through the cup hopper 12 initially to pick up propagating crops 4 and then drop on the next downwardly running portion of the carrier element 8 to the next, downwardly adjoining conveying element 10. The propagating crop is then deflected as a result of gravity in the deflection by the guiding plate 18. During separating out, the propagating crop is thus on one hand removed from the cup hopper 12 by a first conveying element 10, picked up by a conveying element 10 running in advance in the direction of rotation initially in the free drop on the downwardly directed side of the carrier element and transported further in order then subsequently in turn to be moved further by the subsequent guide element 24 in the direction of the output region 26.

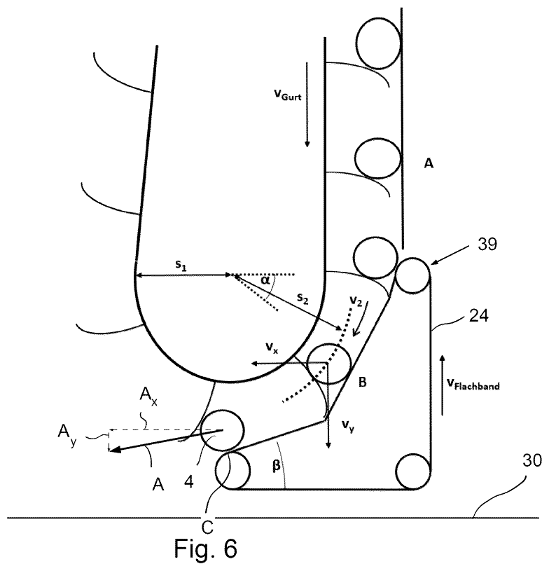

A planting device is particularly advantageous which has as in FIG. 2 on one hand a guide element formed for the deflection of the propagating crops in the form of a guiding plate 18 which deflects the propagating crops 4 in the end region of the sloping part of the carrier element 8 by at least 60°, wherein the propagating crops 4 subsequently arrive at a revolving, further guide element which transfers the propagating crops 4 in the direction of a discharge point C (FIGS. 3 and 6). As a result of the gravitational acceleration and the acceleration of the propagating crop 4 obtained via the revolving belt strip 24, it has in the output region 26 an output direction described by a vector A, the vertical proportion A_{y} of which is smaller than the horizontal proportion Aₓ, relative to the ground 30.

The horizontal proportion Aₓ is opposite to the intended direction of movement F. The carrier element 8 formed as a belt strip according to the embodiment according to FIG. 3 is preferably provided with two deflection elements 34 which are formed as deflection rollers, are arranged during operation at a height above the ground 30 and thus form a carrier element portion 36 which is parallel to the ground 30. As a result of this, an inherent movement in particular parallel to the ground of the conveying elements 10 is performed, which conveying elements in a possible bearing state exert as little impulse as possible and thus relative movement of the propagating crops 4 prior to reaching the discharge region 26. In particular in the exemplary embodiment of FIG. 3, the output direction A is almost parallel to the ground. This applies in particular to exemplary embodiments in which the deflection of the belt strip 24 at the output region is so acute that the propagating crop 4 is almost uninfluenced by gravity at the time of leaving the belt strip 24. In this case, the output direction then also runs almost or completely parallel to the ground 30.

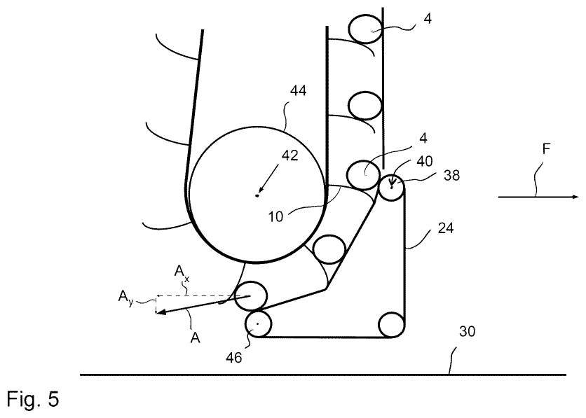

One particularly advantageous variant of a guide apparatus 14 which interacts with the conveying device has a revolving guide element in the form of a belt strip 24 which is supported on its side directed towards the carrier element on the conveying elements 10 so that a conveying region which is closed off in a side view according to FIG. 5 and which migrates with the revolving belt strip and the carrier element 8 is generated between successive conveying elements 10 and the carrier element 8 formed in particular as belt strips and guide element (belt strip 24).

In order to bring about a deflection of the propagating crops 4 which are transported from top to bottom from an almost vertical movement, for this purpose, the revolving belt strip 24, which is deflected by three deflection rollers 38, extends with a rotational axis 40 to a height of a rotational axis 42 of a carrier element deflection roller 44. The upper end portion 39 formed by this deflection roller 38, i.e. the part of the belt strip 24 located above the rotational axis 40 is further spaced apart from the ground 30 than the rotational axis 42 of the deflection element formed by the carrier element deflection roller 44. The distance between the deflection roller 38 and the carrier element with the conveying elements is selected so that the conveying elements 10 necessarily come into contact with the belt strip 24 and tension it with deflecting up to the lower deflection roller which adjoins the output region.

It will be obvious that the strip speeds of the carrier element 8 and of the belt strip 24 can in this case be adjusted to one another. The connection between the conveying elements and the belt strip can, in the case of one variant of the invention, generally be so good that the belt strip is driven by the carrier element or vice versa.

In the case of one configuration according to FIG. 5, the output direction A at the time of discharge is likewise provided with a significantly larger horizontal component Aₓ in comparison with the vertical components, hence as low as possible a relative speed between propagating crop 4 and the ground 30 is present.

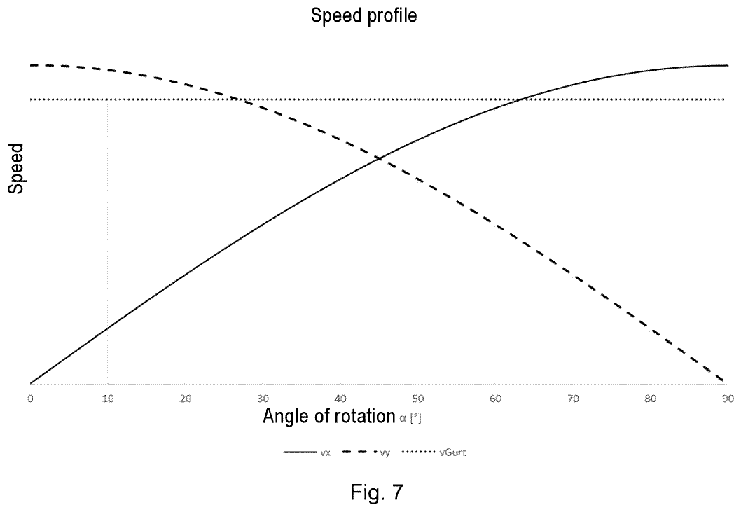

A speed vector comprising vertical components vₓ and v_{y} of a propagating crop according to FIG. 7 theoretically arises for an angle of rotation α. It is apparent in this case that the vertical component, in the case of an arrangement with a lower deflection roller 46 which is sufficiently small in terms of the diameter and an associated direct “release” of the propagating crop 4, leads to a more horizontal discharge of the propagating crop 4, indicated in the case of an angle of rotation of 90°, wherein in this exemplary embodiment the rotational axes of the deflection roller 44 and the lower deflection roller 46 are situated above one another (cf. FIGS. 5 and 6). In the case of an angle of rotation α=0°, the propagating crop has in the case of the present exemplary embodiment an exclusively vertical speed component. In the case of an angle of rotation α>0°, the change in speed of the conveying element is theoretically performed abruptly, insofar as the speed represented in FIG. 7 would be present. In actual fact, as a result of the elasticity of the carrier element, a gradual acceleration of the conveying element from v_{Belt} to v₂ arises so that the real speed profile for v_{y} is modified. The propagating crop moved on the belt strip 24 which revolves with a speed v_{Flat strip}, the increase in speed of which is influenced by gravitational acceleration, then in practice possesses the represented speed profile after an initially lower speed. As a result of the deflection and acceleration of the propagating crop, the propagating crop has at the time of discharge a speed component vₓ which lies above the belt speed v_{Belt}.

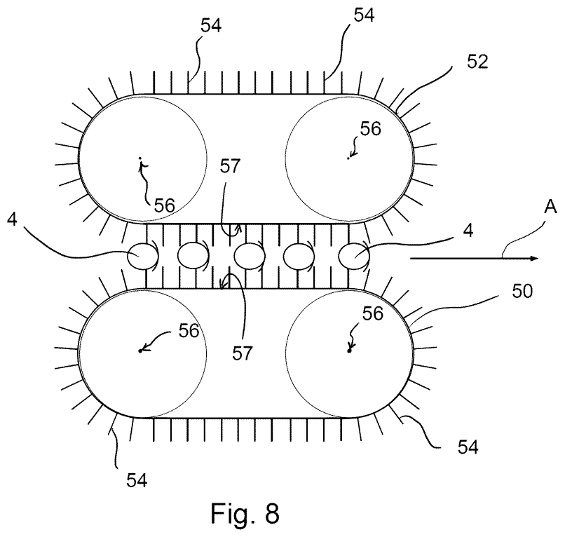

While the previous exemplary embodiments have a belt strip 24 which revolves around horizontal rotational axes as a guide element, the guide element according to FIG. 8 is formed as a guide element formed around rotational axes running vertically to the ground in the form of a guide strip 50. A counter-guidance element 52 formed in mirror-symmetry is in the plan view represented in FIG. 8 correspondingly formed on a side thereof opposite the conveying section of the propagating crops. The counter-guidance element or guide strip 52 has, just like the guide strip 50, driver elements 54 via which propagating crops can be carried along or guided and which extend locally at an angle to the direction of rotation. The guide strips 50 and 52 run in this case around further vertically angled deflection axes 56 which are perpendicular to the ground.

Alternatively, the guide element and the counter-guidance element have outer surfaces 57 which in each case face one another in regions and which, in particular with the omission of driver elements 54, can be formed from a material which is at least partially flexible for a clamping of propagating crops arranged between the guide element and the counter-guidance element.

The guide element and the counter-guidance element of the variant according to FIG. 8 run in portions parallel to one another. Alternatively, the rotational axes 56 can also be formed horizontally to the ground 30, wherein any conveying elements 10 then pivot upwards again in front of the channel formed as a result of this and correspondingly the propagating crops 4 are introduced via an additional guiding plate into this channel which is then formed.

By means of a control device 58, which synchronizes drives 62 of the guide apparatus 14 and the conveying device 6 in terms of drive via control lines 60, in the case of corresponding exemplary embodiments, an actuation of the guide apparatus is generally performed as a function of the speed of movement of the carrier element 10 and possibly of the desired planting distance of the propagating crops 4 so that a rotational speed of the guide element is in particular proportionally dependent on the speed of movement or rotational speed of the carrier element 8 (FIG. 2).

In the exemplary embodiment according to FIG. 5, the guide element formed as a belt strip 24 can be driven passively through contact with the conveying elements 10 through these. Alternatively, the guide element itself can also be equipped with a motoric drive device and be used to drive the carrier element.

1. A planting device for planting root crops the planting device comprising:
a cup hopper for the provisioning of propagating crops to be separated out; and
at least one conveying device which is formed to output the propagating crops, each said conveying device including:
at least one carrier element which revolves in a direction of rotation (U) during operation,
several conveying elements arranged on the carrier element and
a guide apparatus with at least one guide element, which is formed to guide the propagating crops into an output region in such a manner that the propagating crops are output in the output region in an output direction (A) from the planting device,
wherein each respective conveying element describe, during operation, a path which runs through the cup hopper to pick up propagating crops,
wherein the guide apparatus is formed such that a vertical proportion (A_{y}) of the output direction (A) is smaller than a horizontal proportion (Aₓ) of the output direction (A).

2. The planting device according to claim 1, wherein the horizontal proportion (Aₓ) of the output direction (A) is opposite to an intended direction of movement (F) of the planting device during operation.

3. The planting device according to claim 1, wherein the guide element is formed for a deflection of the propagating crops by at least 30°.

4. The planting device according to claim 1, wherein the guide element is formed in a stationary manner relative to a device frame at least during operation.

5. The planting device according to claim 4, wherein the guide element is formed as a guiding surface element with a guiding surface.

6. The planting device according to claim 1, wherein the guide element is formed during operation to be revolving.

7. The planting device of claim 1, including a multiplicity of said guide elements, wherein at least one of the guide elements is formed as a guiding surface element, and one of the guide elements is formed in a revolving manner during operation.

8. The planting device according to claim 1, wherein the carrier element is formed as a belt strip and is mounted by at least two deflection elements which rotate during operation in such a manner that a carrier element portion which adjoins the output region runs during operation at least substantially in a straight line.

9. The planting device according to claim 8, wherein the guide apparatus comprises a counter-guidance element which revolves during operation.

10. The planting device according to claim 1, wherein the guide apparatus comprises several driver elements which revolve during operation.

11. The planting device according to claim 1, wherein the guide apparatus has an upper end portion which is further spaced apart from the ground (30) than a rotational axis of a lower deflection element which rotates during operation and deflects the carrier element.

12. The planting device according to claim 1, wherein the guide apparatus has a roller which rotates during operation with a concave shell surface.

13. The planting device according to claim 1, wherein an element of the guide apparatus is formed in a revolving manner as a deflection axis which is at an angle to a horizontal.

14. The planting device according to claim 9, wherein the guide element and the counter-guidance element have outer surfaces which respectively face one another in regions and which are formed from a material which is at least partially flexible for a clamping of propagating crops arranged between the guide element and the counter-guidance element.

15. The planting device according to claim 9, wherein the guide element runs at least in portions at least substantially parallel to the counter-guidance element or the carrier element.

16. The planting device according to claim 1, further including a control device which actuates the guide apparatus as a function of a speed of movement.

17. The planting device of claim 1, wherein the output direction (A) runs at least approximately horizontally.

18. The planting device according to claim 5, wherein the guide element is formed as a guiding plate, and the guiding surface faces the carrier element, and is provided to centre propagating crops separated out by the conveying elements.

19. The planting device according to claim 6, wherein the guide element is formed during operation in portions bearing against the conveying elements.

20. The planting device of claim 7, wherein at least one of the guide elements is formed as a guiding plate.

21. The planting device according to claim 8, wherein the carrier element is mounted by at least three deflection elements which rotate during operation in such a manner that a carrier element portion which adjoins the output region runs during operation at least substantially in the output direction (A).

22. The planting device according to claim 9, wherein the counter-guidance element revolves during operation at least in portions parallel to the guide element and/or in the output direction (A).

23. The planting device according to claim 10, wherein the driver elements are arranged on the guide element and/or on the counter-guidance element and extend locally at an angle to the direction of rotation.

24. The planting device according to claim 13, wherein the element of the guide apparatus formed in a revolving manner as a deflection axis at a right angle to horizontal.

25. The planting device according to claim 15, wherein the guide element runs at least in portions in a lower end region at least substantially parallel to the counter-guidance element or the carrier element.
